(19) United States
(12) Patent Application Publication
(10) Pub. No.: US 2026/0342797 A1
(43) Pub. Date: Oct. 29, 2026

(54) System and method for generating and securing transient user-specific applications in distributed computing environments

(71) Applicant: Bank of America Corporation, Charlotte, NC (US)

(72) Inventors: Albert H. Hansen, Mooresville, NC (US); David Eugenio Martinez Garza, The Colony, TX (US); Jesus Duarte, Dallas, TX (US); Soma Upadhyay, Lewisville, TX (US); Megha Kandrigal, McKinney, TX (US); Jose Valdez, Richardson, TX (US); Saurabh Gupta, Dwarka (IN); Arpit Tulsyan, Delhi (IN); Subburathinam Krishnan, Chennai (IN); Saurabh Garg, Faridabad (IN); Sandeep Gandhi, Waxhaw, NC (US); Mauli Saluram Kharat, Jalna (IN)

(21) Appl. No.: 19/192,046

(22) Filed: Apr. 28, 2025

(51) Int. Cl. H04L 9/40

(52) U.S. Cl. CPC H04L 63/102; H04L 63/104

(57) ABSTRACT

A system includes a memory configured to store a software application and a primary decentralized dynamic profile associated with a user and a processor operably coupled to the memory and configured to receive a request to execute an interaction with the software application. In response, the processor is configured to execute an iterative adjunction algorithm configured to generate one or more information gain (IG) values based an intent of the interaction, a named entity associated with the interaction, and the primary decentralized dynamic profile and generate the secondary decentralized dynamic profile. The secondary decentralized dynamic profile includes a single-use decentralized dynamic profile configured to facilitate the execution of the interaction with the software application in lieu of the primary decentralized dynamic profile. The processor is configured to execute the interaction with the software application utilizing the secondary decentralized dynamic profile, and, in response, delete the secondary decentralized dynamic profile.

### TECHNICAL FIELD

The present disclosure relates generally to computing security, and, more specifically, to a system and method for generating and securing transient user-specific applications in decentralized computing environments.

### BACKGROUND

Certain web-based environments, such as decentralized web-based environments, may include data being exchanged and stored across any number of decentralized computing systems and databases. For example, the data may include various user data or service data that may be stored to decentralized databases associated with respective entities, and that user data or service data may be exchanged between various decentralized servers and computing systems for servicing end users. However, such decentralized web-based environments may be sometimes subjected to various cyberthreats and deceptive operations.

### SUMMARY

The system and methods implemented by the system as disclosed in the present disclosure provide technical solutions to the technical problems discussed above by generating and utilizing transient decentralized dynamic profiles for efficiently and securely executing interactions in decentralized computing environments. The disclosed system and methods provide several practical applications and technical advantages. Specifically, the present embodiments improve the security, reliability, and maintainability of decentralized software applications (dApps), systems, and sensitive user data, as well as the one or more processors and memory on which the dApps, systems, and sensitive user data may be executed and stored.

Indeed, web-based environments, such as decentralized web-based environments (e.g., Web3 environments), may include data being exchanged and stored across any number of decentralized computing systems and databases. For example, the data may include various user data or service data that may be stored to decentralized databases associated with respective entities, and that user data or service data may be exchanged between various decentralized servers and computing systems for servicing end users. However, such decentralized web-based environments may be sometimes subjected to various cyberthreats and deceptive operations.

For example, in instances in which a user interacts with an unverified dApp or mints a non-fungible token (NFT), for example, a decentralized dynamic profile associated with the user may be susceptible and exposed to various deceptive operations (e.g., “scams,” “spoofing” attacks, phishing attacks, “vishing” attacks, and so forth) intended to gain unauthorized access to their decentralized dynamic profile, and, by extension, unauthorized access sensitive data associated with the user that may be encapsulated by their decentralized dynamic profile.

Accordingly, the present embodiments relate to generating and utilizing transient decentralized dynamic profiles for efficiently and securely executing interactions in decentralized computing environments. Specifically, a decentralized dynamic profile generation system is provided to improve the security, reliability, and maintainability of dApps, systems, and sensitive user data by generating and providing for use transient decentralized dynamic profiles for efficiently and securely executing interactions in decentralized computing environments. For example, in particular embodiments, upon receiving a request to execute an interaction with a dApp, the decentralized dynamic profile generation system may identify an intent of the interaction and one or more named entities associated with the interaction, such as the type of interaction being requested, a priority of the interaction being requested, a limit of the interaction being requested, an amount of data units for processing and validating the interaction being requested, and so forth.

In particular embodiments, the decentralized dynamic profile generation system may then execute an iterative adjunction algorithm that may be suitable for generating one or more information gain (IG) values based on the intent of the interaction, the one or more named entities associated with the interaction, and a primary decentralized dynamic profile associated with the user. As used herein, a “primary decentralized dynamic profile” may refer to one or more cryptographic keys (e.g., private cryptographic key) that may be uniquely assigned to a user and utilized to sign and execute interactions one or more dApps in Web3 environments. For example, in one embodiment, a “primary decentralized dynamic profile” may include a wrapper encapsulating a private cryptographic key uniquely assigned to a user for executing interactions in Web3 environments. In one example, the “primary decentralized dynamic profile” may include a primary decentralized digital wallet associated with a user.

In particular embodiments, the one or more IG values may be indicative of a user preference (e.g., a user-defined configuration setting, a user-defined security setting, a learned user behavior, a user-defined prioritization, a user-defined display customization, and so forth) and an interaction characteristic (e.g., a type of the interaction, a value limit of the interaction, a security level of the interaction, a geolocation of the interaction, a requirement of the interaction, an expiration time of the interaction, and so forth) to be associated with a secondary decentralized dynamic profile once generated. In particular embodiments, the decentralized dynamic profile generation system may then generate the secondary decentralized dynamic profile based on the one or more IG values, in which the secondary decentralized dynamic profile includes a single-use decentralized dynamic profile configured to be utilized to facilitate the execution of the interaction with the dApp in lieu of the primary decentralized dynamic profile and then to be deleted (e.g., destroyed, discarded) immediately thereafter.

In this way, the decentralized dynamic profile generation system may in real-time or near real-time generate a single-use decentralized dynamic profile that may be specifically suited to and utilized to execute a particular interaction, such that even if the single-use decentralized dynamic profile is potentially exposed to various deceptive operations (e.g., “scams,” “spoofing” attacks, phishing attacks, “vishing” attacks, and so forth), the primary decentralized dynamic profile of the user would otherwise remain secured and unperturbed by the potential deceptive operation. Therefore, the present embodiments improve the security, reliability, and maintainability of dApps, systems, and sensitive user data as users execute various interactions within Web3 environments.

Additionally, the present embodiments may minimize interruptions to decentralized computing environments (e.g., blockchain cyberattacks and outages) by preempting deceptive operations (e.g., “scams,” “spoofing” attacks, phishing attacks, “vishing” attacks, and so forth) by adversarial users. Specifically, by generating a single-use decentralized dynamic profile that may be specifically suited to and utilized to execute a particular interaction for each of the individual users of the decentralized computing environments, the efficacy of the tactics, techniques, and procedures (TTPs) of adversarial users may be completely eliminated or at least markedly reduced because the single-use decentralized dynamic profile could not be utilized as an access point to compromise the primary decentralized dynamic profile of the individual users or the decentralized computing environment itself (e.g., blockchain). This may lead to more reliable, robust, and secure decentralized computing environments, and thus may better facilitate, secure, and execute interactions (e.g., cryptocurrency exchanges and executions, NFT exchanges and executions, digital identity management, data storage management, and so forth) in decentralized computing environments amongst individual users.

The present embodiments are directed to systems and methods for generating and securing transient user-specific applications in decentralized computing environments. In particular embodiments, a system includes a memory configured to store at least one software application and a primary decentralized dynamic profile associated with a user. In one embodiment, the primary decentralized dynamic profile may be configured to facilitate an execution of an interaction with the at least one software application. In particular embodiments, the system further includes a processor operably coupled to the memory and configured to receive, from a computing device associated the user, a request to execute an interaction with the at least one software application.

In particular embodiments, in response to receiving the request to execute an interaction with the at least one software application, the processor may then identify, based on the request, an intent of the interaction and one or more named entities associated with the interaction and execute an iterative adjunction algorithm configured to generate one or more information gain (IG) values based at least in part on the intent of the interaction, the one or more named entities associated with the interaction, and the primary decentralized dynamic profile. In one embodiment, the one or more IG values may be indicative of a user preference and an interaction characteristic to be associated with a secondary decentralized dynamic profile once generated.

For example, in one embodiment, the user preference may include one or more of a user-defined configuration setting, a user-defined security setting, a learned user behavior, a user-defined prioritization, or a user-defined display customization. For example, in one embodiment, the interaction characteristic may include one or more of a type of the interaction, a value limit of the interaction, a security level of the interaction, a geolocation of the interaction, a requirement of the interaction, or an expiration time of the interaction.

In particular embodiments, further in response to receiving the request to execute an interaction with the at least one software application, the processor may generate, based on the one or more IG values, the secondary decentralized dynamic profile. For example, in one embodiment, the secondary decentralized dynamic profile may include a single-use decentralized dynamic profile configured to be utilized to facilitate the execution of the interaction with the at least one software application in lieu of the primary decentralized dynamic profile. In particular embodiments, further in response to receiving the request to execute an interaction with the at least one software application, the processor may execute the interaction with the at least one software application utilizing the secondary decentralized dynamic profile, and in response to the execution of the interaction with the at least one software application, delete the secondary decentralized dynamic profile.

In particular embodiments, the processor may be further configured to generate the secondary decentralized dynamic profile by generating a virtual representation of the primary decentralized dynamic profile. In one embodiment, the virtual representation of the primary decentralized dynamic profile may include the secondary decentralized dynamic profile. In particular embodiments, the processor may be further configured to generate the secondary decentralized dynamic profile by configuring the virtual representation of the primary decentralized dynamic profile to match a performance level, a security level, and an interaction efficiency of the primary decentralized dynamic profile.

In one embodiment, the secondary decentralized dynamic profile may be configured in accordance with a first configuration. In particular embodiments, the processor may be further configured to analyze the first configuration based at least in part on the user preference and the interaction characteristic, and to further derive a second configuration for the secondary decentralized dynamic profile based at least in part on the analysis of the first configuration. In one embodiment, the second configuration may be more closely fitted to the user preference and the interaction characteristic as compared to the first configuration. In particular embodiments, the processor may be further configured to reconfigure the secondary decentralized dynamic profile in accordance with the second configuration.

In particular embodiments, the processor may be further configured to generate the secondary decentralized dynamic profile by splitting the primary decentralized dynamic profile into a plurality of secondary decentralized dynamic profiles based at least in part on the one or more IG values. In particular embodiments, prior to executing the interaction with the at least one software application utilizing the secondary decentralized dynamic profile, the processor may be further configured to execute a simulation model configured to simulate the interaction with the at least one software application utilizing the secondary decentralized dynamic profile to evaluate a response time and latency associated with the execution of the interaction.

In particular embodiments, prior to executing the interaction with the at least one software application utilizing the secondary decentralized dynamic profile, and, further in response to determining that the evaluated response time and latency associated with the execution of the interaction satisfies a predetermined response time and latency threshold, the processor may be further configured to execute the interaction with the at least one software application utilizing the secondary decentralized dynamic profile.

In particular embodiments, subsequent to deleting the secondary decentralized dynamic profile, the processor may be further configured to train a machine-learning algorithm based at least in part on the request to execute the interaction with the at least one software application and the execution of the interaction with the at least one software application utilizing the secondary decentralized dynamic profile, and further to execute, in response to the training of the machine-learning algorithm, a machine-learning model to generate a user recommendation for one or more future interactions with the at least one software application.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a cloud computing system, in accordance with certain aspects of the present disclosure;

FIG. 2A illustrates a workflow diagram of a decentralized dynamic profile generation system, in accordance with one or more embodiments of the present disclosure;

FIG. 2B illustrates a workflow and architectural diagram of an iterative generation system, in accordance with one or more embodiments of the present disclosure; and

FIG. 3 illustrates a flowchart of an example method for generating and utilizing transient decentralized dynamic profiles for efficiently and securely executing interactions in decentralized computing environments, in accordance with one or more embodiments of the present disclosure.

### DETAILED DESCRIPTION

### Example System

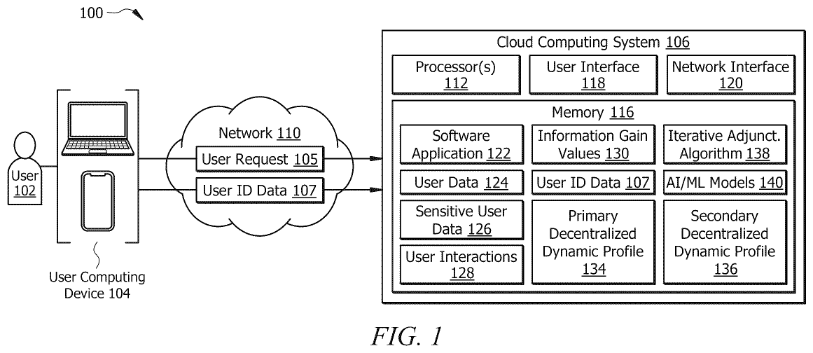

FIG. 1 is a block diagram of a cloud computing system 100. In particular embodiments, the system 100 may include a user computing device 104 associated with a user 102, a cloud computing system 106, and a network 110. In particular embodiments, the user 102 may include a user associated with an institution, an organization, or an entity that receives user data (e.g., user data 124) and hosts and maintain sensitive user data (e.g., sensitive user data 126) that may be associated with the user 102. The network 110 enables communications and exchanges of data among components of the system 100, such as the user computing device 104 and the cloud computing system 106.

In general, the system 100 may be utilized to generate and utilize transient decentralized dynamic profiles (e.g., secondary decentralized dynamic profile 136) for efficiently and securely executing user interactions 128 in decentralized computing environments. In particular embodiments, the cloud computing system 106 may include one or more processor(s) 112 in signal communication with a memory 116. The memory 116 stores instructions that when executed by the processor(s) 112, cause the processor(s) 112 to perform one or more functions described herein. For example, when the instructions are executed, the processor(s) 112 may receive, from the computing device 104, a user request 105 to execute a user interaction 128 with the software application 122 and user identification data 107. The processor(s) 112 may further execute an iterative adjunction algorithm 138 configured to generate one or more information gain (IG) values 130 based on an intent of a user interaction 128, one or more named entities associated with the user interaction 128, and the primary decentralized dynamic profile 134.

In one embodiment, the one or more IG values 130 may be indicative of a user preference and an interaction characteristic to be associated with the secondary decentralized dynamic profile 136 once generated. In particular embodiments, when the instructions are executed, the processor(s) 112 may further generate, based on the one or more IG values 130, the secondary decentralized dynamic profile 136. In one embodiment, the secondary decentralized dynamic profile 136 may include a single-use decentralized dynamic profile configured to be utilized to facilitate the execution of the user interaction 128 with the software application 122 in lieu of the primary decentralized dynamic profile 134. In particular embodiments, when the instructions are executed, the processor(s) 112 may further execute the user interaction 128 with the software application 122 utilizing the secondary decentralized dynamic profile 136, and in response to the execution of the user interaction 128 with the software application 122, delete the secondary decentralized dynamic profile 136.

The cloud computing system 100 may be configured as shown, or in any other configuration. In one embodiment, the cloud computing system 106 may include a private cloud computing and storage system, which may include, for example, a cloud computing environment and infrastructure that may be managed, controlled, and dedicated to a single organization or entity. In another embodiment, the cloud computing system 106 may include a hybrid cloud computing and storage system, which may include, for example, a mixed computing environment and infrastructure in which software applications are executing utilizing some combination of computing, storage, and services in both private cloud environments and public cloud environments. Still, in another embodiment, the cloud computing system 106 may include a public cloud computing and storage system, which may include, for example, a cloud computing environment and infrastructure that may be serviced to any number of organizations or entities as virtual resources accessible over the internet.

### System Components

### Network

The network 110 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 110 may be configured to support any suitable type of communication protocol as would be appreciated by one of ordinary skill in the art.

### Cloud Computing System

In particular embodiments, the cloud computing system 106 may include any computing system that may be utilized to process data and communicate with computing devices (e.g., user computing device 104), databases, or other computing systems via the network 110. The cloud computing system 106 may be utilized to oversee operations of the processor(s) 112. In particular embodiments, the cloud computing system 106 may include the processor(s) 112 in signal communication with a network interface 120, a user interface 118, and memory 116. The cloud computing system 106 may be configured as shown, or in any other configuration.

The processor(s) 112 may include one or more processors operably coupled to the memory 116. The processor(s) 112 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor(s) 112 may be a programmable logic device, a microcontroller, a microprocessor, or any suitable combination of the preceding. The processor(s) 112 may be communicatively coupled to and in signal communication with the network interface 120, user interface 118, and memory 116. The one or more processors may be utilized to process data and may be implemented in hardware, software, or some combination thereof.

For example, the processor(s) 112 may be 8-bit, 16-bit, 32-bit, 64-bit or of any other suitable architecture. The processor(s) 112 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processor(s) 112 are configured to implement various instructions. For example, the one or more processors may be utilized to execute the software application 122 to implement the functions disclosed herein, such as some or all of those described with respect to FIGS. 1-3. In some embodiments, the function described herein is implemented using logic units, FPGAs, ASICs, DSPs, or any other suitable hardware or electronic circuitry.

The network interface 120 may be utilized to enable wired and/or wireless communications (e.g., via the network 110). The network interface 120 may be utilized to communicate data between the cloud computing system 106 and other network devices, systems, or domain(s). For example, the network interface 120 may comprise a WIFI interface, a local area network (LAN) interface, a wide area network (WAN) interface, a modem, a switch, or a router. The processor(s) 112 may be configured to send and receive data using the network interface 120. The network interface 120 may be configured to use any suitable type of communication protocol.

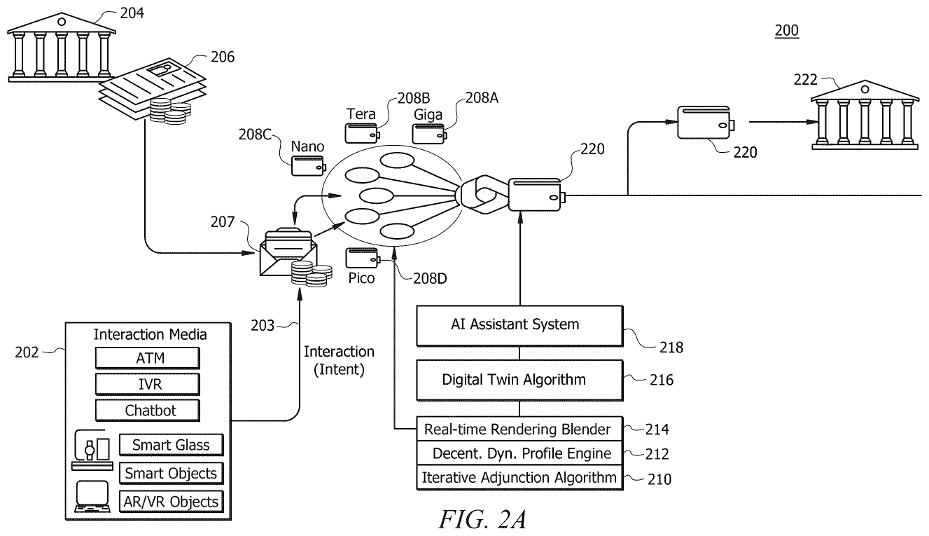

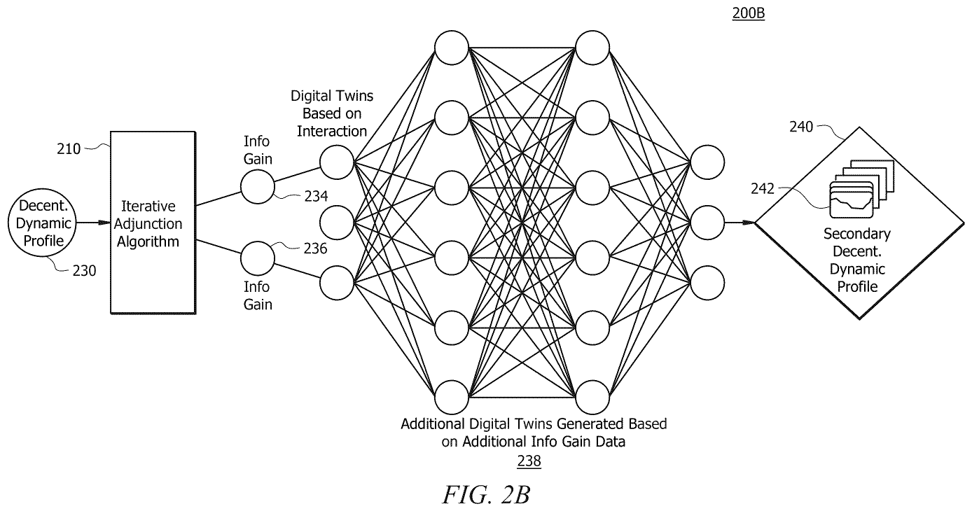

The memory 116 may be volatile or non-volatile and may include a read-only memory (ROM), random-access memory (RAM), ternary content-addressable memory (TCAM), dynamic random-access memory (DRAM), and static random-access memory (SRAM), or other non-transitory computer-readable medium. The memory 116 may be implemented using one or more disks, tape drives, solid-state drives, and/or the like. As will be discussed in greater detail below with respect to FIG. 2, the memory 116 may be operable to store the software application 122, user data 124, sensitive user data 126, user interactions 128, information gain (IG) values 130, user identification data 107, iterative adjunction algorithm 138, primary decentralized dynamic profile 134, secondary decentralized dynamic profile 136, one or more generative artificial intelligence (AI)/machine-learning (ML) models 140, and/or any other data, instructions, or compute engines.

The memory 116 may also store instances of software application 122 that may be executing within the system 100. In one embodiment, the instances of a software application 122 may include any number of instances a large software application suitable for hosting and servicing thousands or millions of individual users 102 that may interact via user computing devices 104 with the cloud computing system 106. The users 102 may be further associated with the sensitive user data 126.

### Processor(s)

In accordance with the presently disclosed embodiments, the processor(s) 112 may receive a user request 105 from the user computing device 104 to initiate an execution of one or more user interactions 128 with the software application 122. In particular embodiments, the processor(s) 112 may execute the iterative adjunction algorithm 138 configured to generate one or more information gain (IG) values 130 based on an intent of a user interaction 128, one or more named entities associated with the user interaction 128, and the primary decentralized dynamic profile 134, and further generate, based on the one or more IG values 130, the secondary decentralized dynamic profile 136.

In one embodiment, the secondary decentralized dynamic profile 136 may include a single-use decentralized dynamic profile configured to be utilized to facilitate the execution of the user interaction 128 with the software application 122 in lieu of the primary decentralized dynamic profile 134. In particular embodiments, the processor(s) 112 may further execute the user interaction 128 with the software application 122 utilizing the secondary decentralized dynamic profile 136, and, in response to the execution of the user interaction 128 with the software application 122, delete the secondary decentralized dynamic profile 136.

In one embodiment, the one or more machine-learning models 140 may include one or more of a language model (LM), a large language model (LLM), a bidirectional and auto-regressive transformer (BART) model, a bidirectional encoder representations for transformer (BERT) model, or a generative pre-trained transformer (GPT) model. In another embodiment, the one or more machine-learning models 140 may include one or more of a neuromorphic image compression (NIC) model, a convolutional neural network (CNN), a spiking neural network (SNN), an autoencoder (AE), a variational autoencoder (VAE), a generative adversarial network (GAN), or a bidirectional generative adversarial network (BiGAN).

### Generating and Utilizing Transient Decentralized Dynamic Profiles for Efficiently and Securely Executing Interactions in Decentralized Computing Environments

Embodiments of the present disclosure discuss techniques for generating and utilizing transient decentralized dynamic profiles for efficiently and securely executing interactions in decentralized computing environments.

FIG. 2 illustrates a workflow diagram of a decentralized dynamic profile generation system 200 for generating and utilizing transient decentralized dynamic profiles for efficiently and securely executing interactions in decentralized computing environments, in accordance with certain aspects of the present disclosure. In one embodiment, the workflow diagram of the decentralized dynamic profile generation system 200 may be performed solely by the cloud computing system 106 as discussed above with respect to FIG. 1. For example, in one or more embodiments, the decentralized dynamic profile generation system 200 may be included as part of the cloud computing system 106 and may be executed utilizing the one or more processor(s) 112.

Specifically, as will be discussed in detail with respect to FIG. 2, the present embodiments are directed to a decentralized dynamic profile generation system 200 provided to improve the security, reliability, and maintainability of dApps (e.g., software application 122), systems (e.g., cloud computing system 106), and sensitive user data (e.g., sensitive user data 126) by generating and providing for use a transient decentralized dynamic profile (e.g., secondary decentralized dynamic profile 242) for efficiently and securely executing interactions in Web3 environments.

For example, as depicted by FIG. 2, the workflow of the decentralized dynamic profile generation system 200 may begin with accessing or receiving a request to execute an interaction 203 with a dApp, such as dApp that may be associated with an organization 222. For example, in some embodiments, the user 102 may provide a request to execute an interaction 203 with the organization 222, such as an interaction precipitating to an exchange data units associated with the user 102 or owned by the user 102 for obtaining for the user 102 one or more data elements (e.g., user obtainable products) associated with the organization 222, one or more data services (e.g., user obtainable services) associated with the organization 222, one or more data units (e.g., user obtainable exchange units) associated with the organization 222, or one or more other data entities associated with the organization 222 that may be desired and obtained by the user 102 via interactions with a dApp.

In particular embodiments, as further depicted by FIG. 2, the user 102 may provide a request via any interaction media 202, such as a personal electronic device (e.g., a phone, a laptop, a tablet, and so forth), an automated telecommunications interaction system (e.g., ATM), an interactive voice response (IVR) system, one or more wearable electronic devices (e.g., a pair of smart glasses, a watch, a wristband, a an extended reality (XR) device, and so forth), a chatbot, or other interaction media 202 that may be utilized by the user 102. In particular embodiments, upon receiving the request to execute the interaction 203, the workflow of the decentralized dynamic profile generation system 200 may then continue with identifying an intent of the interaction 203 and one or more named entities associated with the interaction.

For example, in one embodiment, the decentralized dynamic profile generation system 200 may identify the intent of the interaction 203 and one or more named entities associated with the interaction 203 by identifying, for example, a type of interaction 203 being requested (e.g., an e-commerce interaction, a dynamic service interaction, a user entertainment interaction, a utility system interaction, and so forth), a priority of the interaction 203 being requested (e.g., a high-priority interaction, a moderate-priority interaction, a low-priority interaction), a limit of the interaction 203 being requested (e.g., a user-defined maximum value or minimum value of the interaction), an amount of data units for processing and validating the interaction 203 being requested, and so forth.

In particular embodiments, the workflow of the decentralized dynamic profile generation system 200 may then continue with accessing or receiving user authentication data 206 to verify an identity of the user 102 associated with the request to execute the interaction 203. In one embodiment, the user authentication data 206 may include user authentication data that may be stored and maintained by a trusted organization 204, such as a username and password, a digital signature, one or more identification (ID) tokens, one or more access tokens, one or more biometric inputs, or identification data that may be utilized to uniquely identify the user 102. In another embodiment, the user authentication data 206 may include a private cryptographic key or a cryptographic signature that may be utilized to establish ownership of blockchain address associated with the user 102.

In particular embodiments, the workflow of the decentralized dynamic profile generation system 200 may then continue with accessing a primary decentralized dynamic profile 207 that may be associated with the user 102. For example, in one embodiment, the primary decentralized dynamic profile 207 may include a wrapper encapsulating a private cryptographic key uniquely assigned to the user 102 for executing the interaction 203 requested by the user 102. In particular embodiments, the workflow of the decentralized dynamic profile generation system 200 may then continue with accessing a primary decentralized dynamic profile 207 that may be associated with the user 102.

In particular embodiments, the workflow of the decentralized dynamic profile generation system 200 may then continue with executing one or more of an iterative adjunction algorithm 210, a decentralized dynamic profile engine 212, a real-time rendering blender 214, a digital twin algorithm 216, and an artificial-intelligence (AI) assistant system 218 that may be suitable for generating a secondary decentralized dynamic profile 220. For example, in particular embodiments, the secondary decentralized dynamic profile 220 may include a single-use decentralized dynamic profile that may be utilized to facilitate the execution of the interaction 203 in lieu of the primary decentralized dynamic profile 207.

For example, as will be discussed further with respect to FIG. 2B, the iterative adjunction algorithm 210 that may be utilized to generate one or more information gain (IG) values, which may be utilized to split the primary decentralized dynamic profile 207 into any number of secondary decentralized dynamic profiles 208A (e.g., Giga decentralized dynamic profile), 208B (e.g., Tera decentralized dynamic profile), 208C (e.g., Nano decentralized dynamic profile), and 208A (e.g., Pico decentralized dynamic profile). In some embodiments, the number of secondary decentralized dynamic profiles 208A (e.g., Giga decentralized dynamic profile), 208B (e.g., Tera decentralized dynamic profile), 208C (e.g., Nano decentralized dynamic profile), and 208A (e.g., Pico decentralized dynamic profile) may each include a secondary decentralized dynamic profile that may be generated and suited to one or more user preferences or interaction characteristics.

For example, in one embodiment, the user preference may include one or more of a user-defined configuration setting, a user 102 defined security setting, a learned user 102 behavior, a user 102 defined prioritization, or a user 102 defined display customization. In one example, the user preference may include one or more financial goals, an allowance management user 102 preference, one or more content control user 102 preferences, a multiuser financial management preference, a transaction processing speed user 102 preference, and so forth.

Similarly, in particular embodiments, the interaction characteristic may include one or more of a type of the interaction 203, a value limit of the interaction 203, a security level of the interaction 203, a geolocation of the interaction 203, a requirement of the interaction 203 (e.g., a software requirement, a compatibility requirement, and so forth), or an expiration time of the interaction (e.g., a time of day, a time of week, a time of year, and so forth). In one example, the interaction characteristic may include a transaction type, a transaction priority, a transaction limits, a transaction fee, a gas fee, a security, a currency type, a transaction size, one or more expiration dates, and so forth.

In particular embodiments, the digital twin algorithm 216 may include a service that may be utilized to generate the secondary decentralized dynamic profile 220 by generating one or more virtual representations of the primary decentralized dynamic profile 207, and configuring the virtual representation of the primary decentralized dynamic profile 207 to match and fit to a performance level, a security level, and an interaction efficiency of the primary decentralized dynamic profile 207. For example, in particular embodiments, the digital twin algorithm 216 may access the primary decentralized dynamic profile 207 and snapshot and ingest various data (e.g., performance level, security level, interaction efficiency, configuration data, and so forth) of the primary decentralized dynamic profile 207.

In particular embodiments, the digital twin algorithm 216 may then generate a “digital twin” (e.g., a virtual representation of an object or a system designed to reflect a physical object or digital object and its configurations accurately) of the primary decentralized dynamic profile 207, and thus providing an identical or nearly identical virtual model or replica representing the secondary decentralized dynamic profile 220. In particular embodiments, the digital twin algorithm 216 may continuously update the “digital twin” representing the secondary decentralized dynamic profile 220 to reflect updates and changes (e.g., changes to interaction type, interaction priority, interaction limits, interaction units of measure, interaction security, interaction size, expiration dates, and so forth) to the primary decentralized dynamic profile 207. In a similar manner, the real-time rendering blender 214 utilizes blender technology to create an interactive, visual representation of the “digital twin” representing the secondary decentralized dynamic profile 220.

In particular embodiments, the AI assistant system 218 may be utilized to generate one or more user recommendations for one or more future interactions with the dApp associated with the organization 222, for example. For example, in one embodiment, the AI assistant system 218 may include an artificial-intelligence algorithm that may be iteratively trained based on the interaction(s) 203 and the final execution of the interaction 203 utilizing the secondary decentralized dynamic profile 220. For example, the AI assistant system 218 may be trained and fine-tuned over time to on a large data set of interactions 203 and the executions thereof to learn, for example, general preferences of the user 102, particular likes and dislikes of the user 102, value ranges of interactions 203 successfully executed by the user 102 utilizing the secondary decentralized dynamic profile 220, persons, places, and items of interest to the user 102, and so forth.

In particular embodiments, upon training and/or fine-tuning of the AI assistant system 218, the AI assistant system 218 may be then executed to generate one or more user recommendations (e.g., personalized suggestions of data items of interest to the user 102) for one or more future interactions 203 with the dApp associated with the organization 222. In particular embodiments, the workflow of the decentralized dynamic profile generation system 200 may then continue with executing the requested interaction 203 utilizing the secondary decentralized dynamic profile 220. In particular embodiments, the workflow of the decentralized dynamic profile generation system 200 may then conclude with deleting (e.g., discarding, destroying) the secondary decentralized dynamic profile 220 immediately following the execution of the requested interaction 203 utilizing the secondary decentralized dynamic profile 220.

In this way, the decentralized dynamic profile generation system 200 may in real-time or near real-time generate a single-use secondary decentralized dynamic profile 220 that may be specifically suited to and utilized to execute the interaction 203, such that even if the single-use secondary decentralized dynamic profile 220 is potentially exposed to various deceptive operations (e.g., “scams,” “spoofing” attacks, phishing attacks, “vishing” attacks, and so forth), the primary decentralized dynamic profile 207 of the user 102 would otherwise remain secured and unperturbed by the potential deceptive operation. Therefore, the present embodiments improve the security, reliability, and maintainability of dApps, systems, and sensitive user data as users execute various interactions within Web3 environments.

FIG. 2B illustrates a workflow and architectural diagram of an iterative generation system, in accordance with one or more embodiments of the present disclosure. As generally discussed above with respect to FIG. 2A, an iterative adjunction algorithm 210 may be utilized to generate one or more information gain (IG) values 234, 236 that may be utilized to split the primary decentralized dynamic profile 230, for example, into any number of “digital twins” 238 of the primary decentralized dynamic profile 230. For example, the “digital twins” 238 of the primary decentralized dynamic profile 230 may correspond to outputs 240 of respective secondary decentralized dynamic profiles 242.

For example, in one embodiment, the iterative adjunction algorithm 210 may include one or more decision trees that may be utilized to split a predictor space or a target variable into different subgroups that are relatively more homogenous from the perspective of the target variable. For example, in the instance in which the target variable is binary with categories “1” and “0,” for instance, then the decision tree operates to split the target variable space into subgroups that are more homogenous in terms of having either “1's” or “0's.” Thus, in accordance with the presently disclosed embodiments, the IG values 234, 236 may each include, for example, a measure used to determine which “feature” should be utilized to split the primary decentralized dynamic profile 230 at each internal node of the decision tree of the iterative adjunction algorithm 210.

In particular embodiments, the IG values 234, 236 may include “features” indicative of a user 102 preference, such as a user 102 defined configuration setting, a user 102 defined security setting, a learned user 102 behavior, a user 102 defined prioritization, a user 102 defined display customization, and so forth. Similarly, the IG values 234, 236 may include “features” indicative of a user 102 an interaction 203 characteristic, such as a type of the interaction 203, a value limit of the interaction 203, a security level of the interaction 203, a geolocation of the interaction 203, a requirement of the interaction 203, an expiration time of the interaction, and so forth to be associated with the respective secondary decentralized dynamic profiles 242 once generated.

It should be appreciated that the IG values 234, 236 may include any “features” that may be utilized to generate the secondary decentralized dynamic profiles 242. For example, in other embodiments, the IG values 234, 236 may include “features” representative general preferences of the user 102, particular likes and dislikes of the user 102, value ranges of interactions 203 successfully executed by the user 102 utilizing the secondary decentralized dynamic profile 220, persons, places, and items of interest to the user 102, and so forth.

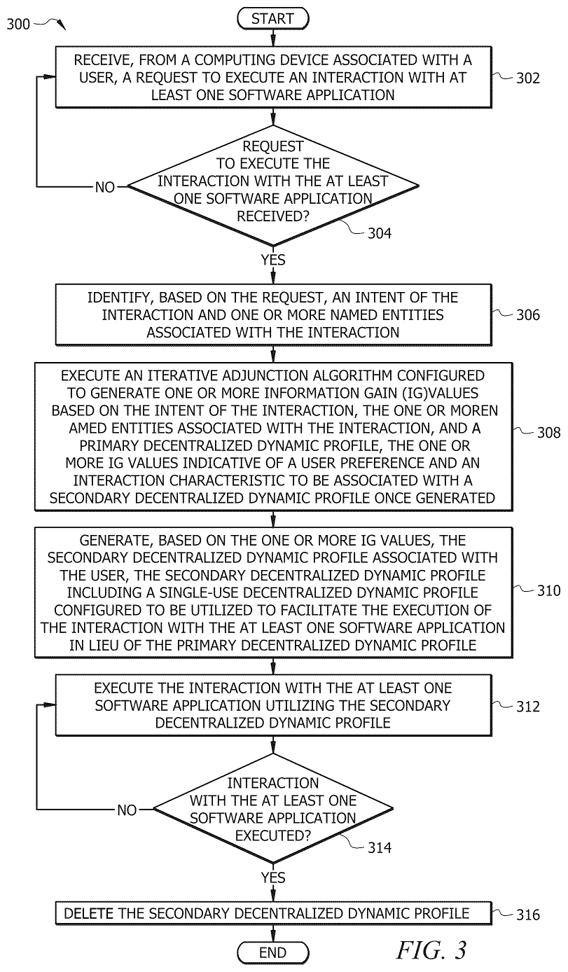

FIG. 3 illustrates a flowchart of an example method 300 for generating and utilizing transient decentralized dynamic profiles for efficiently and securely executing interactions in decentralized computing environments, in accordance with one or more embodiments of the present disclosure. The method 300 may be performed by the cloud computing system 106 as described above with respect to FIG. 1. The method 300 may begin at block 302 with the one or more processor(s) 112 receiving, from a computing device 104 associated a user 102, a request 105 to execute an interaction 128 with a software application 122. The method 300 may continue at decision 304 with the one or more processor(s) 112 confirming whether the request 105 to execute the interaction 128 with the software application 122 has been received.

In particular embodiments, in response to confirming that the request 105 to execute the interaction 128 with the software application 122 has not been received (e.g., at decision 304), the method 300 may return to block 302. On the other hand, in response to confirming that the request 105 to execute the interaction 128 with the software application 122 has been received (e.g., at decision 304), the method 300 may continue at block 306 with the one or more processor(s) 112 identifying, based on the request 105, an intent of the interaction 128 and one or more named entities associated with the interaction 128.

In particular embodiments, the method 300 may then continue at block 308 with the one or more processor(s) 112 executing an iterative adjunction algorithm 138 configured to generate one or more information gain (IG) values 130 based on the intent of the interaction 128, the one or more named entities associated with the interaction 128, and a primary decentralized dynamic profile 134. For example, in one embodiment, the one or more IG values 130 may be indicative of a user 102 preference and an interaction 128 characteristic to be associated with a secondary decentralized dynamic profile 136 once generated. In particular embodiments, the method 300 may then continue at block 310 with the one or more processor(s) 112 generating, based on the one or more IG values 130, the secondary decentralized dynamic profile 136.

For example, in one embodiment, the secondary decentralized dynamic profile 136 may include a single-use decentralized dynamic profile configured to be utilized to facilitate the execution of the interaction 128 with the at least one software application 122 in lieu of the primary decentralized dynamic profile 134. In particular embodiments, the method 300 may then continue at block 312 with the one or more processor(s) 112 executing the interaction 128 with the software application 122 utilizing the secondary decentralized dynamic profile 136. In particular embodiments, the method 300 may continue at decision 314 with the one or more processor(s) 112 confirming whether the interaction 128 with the software application 122 utilizing the secondary decentralized dynamic profile 136 has been executed.

In particular embodiments, in response to confirming that the interaction 128 with the software application 122 utilizing the secondary decentralized dynamic profile 136 has not been executed (e.g., at decision 314), the method 300 may return to block 312. On the other hand, in response to confirming that the interaction 128 with the software application 122 utilizing the secondary decentralized dynamic profile 136 has been executed (e.g., at decision 314), the method 300 may conclude at block 316 with the one or more processor(s) 112 deleting the secondary decentralized dynamic profile 136.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store at least one software application and a primary decentralized dynamic profile associated with a user, wherein the primary decentralized dynamic profile is configured to facilitate an execution of an interaction with the at least one software application; and
a processor operably coupled to the memory and configured to:
receive, from a computing device associated the user, a request to execute an interaction with the at least one software application, and, in response:
identify, based on the request, an intent of the interaction and one or more named entities associated with the interaction;
execute an iterative adjunction algorithm configured to generate one or more information gain (IG) values based at least in part on the intent of the interaction, the one or more named entities associated with the interaction, and the primary decentralized dynamic profile, wherein the one or more IG values are indicative of a user preference and an interaction characteristic to be associated with a secondary decentralized dynamic profile once generated;
generate, based at least in part on the one or more IG values, the secondary decentralized dynamic profile, wherein the secondary decentralized dynamic profile comprises a single-use decentralized dynamic profile configured to be utilized to facilitate the execution of the interaction with the at least one software application in lieu of the primary decentralized dynamic profile;
execute the interaction with the at least one software application utilizing the secondary decentralized dynamic profile; and
in response to the execution of the interaction with the at least one software application, delete the secondary decentralized dynamic profile.

2. The system of claim 1, wherein the processor is further configured to generate the secondary decentralized dynamic profile by:
generating a virtual representation of the primary decentralized dynamic profile, wherein the virtual representation of the primary decentralized dynamic profile comprises the secondary decentralized dynamic profile; and
configuring the virtual representation of the primary decentralized dynamic profile to match a performance level, a security level, and an interaction efficiency of the primary decentralized dynamic profile.

3. The system of claim 1, wherein the secondary decentralized dynamic profile is configured in accordance with a first configuration, and wherein the processor is further configured to:
analyze the first configuration based at least in part on the user preference and the interaction characteristic;
derive a second configuration for the secondary decentralized dynamic profile based at least in part on the analysis of the first configuration, wherein the second configuration is more closely fitted to the user preference and the interaction characteristic as compared to the first configuration; and
reconfigure the secondary decentralized dynamic profile in accordance with the second configuration.

4. The system of claim 1, wherein the processor is further configured to generate the secondary decentralized dynamic profile by splitting the primary decentralized dynamic profile into a plurality of secondary decentralized dynamic profiles based at least in part on the one or more IG values.

5. The system of claim 1, wherein the processor is further configured to:
prior to executing the interaction with the at least one software application utilizing the secondary decentralized dynamic profile:
execute a simulation model configured to simulate the interaction with the at least one software application utilizing the secondary decentralized dynamic profile to evaluate a response time and latency associated with the execution of the interaction; and
in response to determining that the evaluated response time and latency associated with the execution of the interaction satisfies a predetermined response time and latency threshold, execute the interaction with the at least one software application utilizing the secondary decentralized dynamic profile.

6. The system of claim 1, wherein the processor is further configured to:
subsequent to deleting the secondary decentralized dynamic profile:
train an artificial-intelligence algorithm based at least in part on the request to execute the interaction with the at least one software application and the execution of the interaction with the at least one software application utilizing the secondary decentralized dynamic profile; and
execute, in response to the training of the artificial-intelligence algorithm, an artificial-intelligence model to generate a user recommendation for one or more future interactions with the at least one software application.

7. The system of claim 1, wherein:
the user preference comprises one or more of a user-defined configuration setting, a user-defined security setting, a learned user behavior, a user-defined prioritization, or a user-defined display customization; and
the interaction characteristic comprises one or more of a type of the interaction, a value limit of the interaction, a security level of the interaction, a geolocation of the interaction, a requirement of the interaction, or an expiration time of the interaction.

8. A method, comprising:
receiving, from a computing device associated a user, a request to execute an interaction with at least one software application, and, in response:
identifying, based on the request, an intent of the interaction and one or more named entities associated with the interaction;
executing an iterative adjunction algorithm configured to generate one or more information gain (IG) values based at least in part on the intent of the interaction, the one or more named entities associated with the interaction, and a primary decentralized dynamic profile, wherein the one or more IG values are indicative of a user preference and an interaction characteristic to be associated with a secondary decentralized dynamic profile once generated;
generating, based at least in part on the one or more IG values, the secondary decentralized dynamic profile, wherein the secondary decentralized dynamic profile comprises a single-use decentralized dynamic profile configured to be utilized to facilitate the execution of the interaction with the at least one software application in lieu of the primary decentralized dynamic profile;
executing the interaction with the at least one software application utilizing the secondary decentralized dynamic profile; and
in response to the execution of the interaction with the at least one software application, deleting the secondary decentralized dynamic profile.

9. The method of claim 8, further comprising generating the secondary decentralized dynamic profile by:
generating a virtual representation of the primary decentralized dynamic profile, wherein the virtual representation of the primary decentralized dynamic profile comprises the secondary decentralized dynamic profile; and
configuring the virtual representation of the primary decentralized dynamic profile to match a performance level, a security level, and an interaction efficiency of the primary decentralized dynamic profile.

10. The method of claim 8, wherein the secondary decentralized dynamic profile is configured in accordance with a first configuration, the method further comprising:
analyzing the first configuration based at least in part on the user preference and the interaction characteristic;
deriving a second configuration for the secondary decentralized dynamic profile based at least in part on the analysis of the first configuration, wherein the second configuration is more closely fitted to the user preference and the interaction characteristic as compared to the first configuration; and
reconfiguring the secondary decentralized dynamic profile in accordance with the second configuration.

11. The method of claim 8, further comprising generating the secondary decentralized dynamic profile by splitting the primary decentralized dynamic profile into a plurality of secondary decentralized dynamic profiles based at least in part on the one or more IG values.

12. The method of claim 8, further comprising:
prior to executing the interaction with the at least one software application utilizing the secondary decentralized dynamic profile:
executing a simulation model configured to simulate the interaction with the at least one software application utilizing the secondary decentralized dynamic profile to evaluate a response time and latency associated with the execution of the interaction; and
in response to determining that the evaluated response time and latency associated with the execution of the interaction satisfies a predetermined response time and latency threshold, executing the interaction with the at least one software application utilizing the secondary decentralized dynamic profile.

13. The method of claim 8, further comprising:
subsequent to deleting the secondary decentralized dynamic profile:
training an artificial-intelligence algorithm based at least in part on the request to execute the interaction with the at least one software application and the execution of the interaction with the at least one software application utilizing the secondary decentralized dynamic profile; and
executing, in response to the training of the artificial-intelligence algorithm, an artificial-intelligence model to generate a user recommendation for one or more future interactions with the at least one software application.

14. The method of claim 8, wherein:
the user preference comprises one or more of a user-defined configuration setting, a user-defined security setting, a learned user behavior, a user-defined prioritization, or a user-defined display customization; and
the interaction characteristic comprises one or more of a type of the interaction, a value limit of the interaction, a security level of the interaction, a geolocation of the interaction, a requirement of the interaction, or an expiration time of the interaction.

15. A non-transitory computer-readable medium storing instructions that, when executed by one or more processors, cause the one or more processors to:
receive, from a computing device associated a user, a request to execute an interaction with at least one software application, and, in response:
identify, based on the request, an intent of the interaction and one or more named entities associated with the interaction;
execute an iterative adjunction algorithm configured to generate one or more information gain (IG) values based at least in part on the intent of the interaction, the one or more named entities associated with the interaction, and a primary decentralized dynamic profile, wherein the one or more IG values are indicative of a user preference and an interaction characteristic to be associated with a secondary decentralized dynamic profile once generated;
generate, based at least in part on the one or more IG values, the secondary decentralized dynamic profile, wherein the secondary decentralized dynamic profile comprises a single-use decentralized dynamic profile configured to be utilized to facilitate the execution of the interaction with the at least one software application in lieu of the primary decentralized dynamic profile;
execute the interaction with the at least one software application utilizing the secondary decentralized dynamic profile; and
in response to the execution of the interaction with the at least one software application, delete the secondary decentralized dynamic profile.

16. The non-transitory computer-readable medium of claim 15, wherein the instructions further cause the one or more processors to generate the secondary decentralized dynamic profile by:
generating a virtual representation of the primary decentralized dynamic profile, wherein the virtual representation of the primary decentralized dynamic profile comprises the secondary decentralized dynamic profile; and
configuring the virtual representation of the primary decentralized dynamic profile to match a performance level, a security level, and an interaction efficiency of the primary decentralized dynamic profile.

17. The non-transitory computer-readable medium of claim 15, wherein the secondary decentralized dynamic profile is configured in accordance with a first configuration, and wherein the instructions further cause the one or more processors to:
analyze the first configuration based at least in part on the user preference and the interaction characteristic;
derive a second configuration for the secondary decentralized dynamic profile based at least in part on the analysis of the first configuration, wherein the second configuration is more closely fitted to the user preference and the interaction characteristic as compared to the first configuration; and
reconfigure the secondary decentralized dynamic profile in accordance with the second configuration.

18. The non-transitory computer-readable medium of claim 15, wherein the instructions further cause the one or more processors to generate the secondary decentralized dynamic profile by splitting the primary decentralized dynamic profile into a plurality of secondary decentralized dynamic profiles based at least in part on the one or more IG values.

19. The non-transitory computer-readable medium of claim 15, wherein the instructions further cause the one or more processors to:
prior to executing the interaction with the at least one software application utilizing the secondary decentralized dynamic profile:
execute a simulation model configured to simulate the interaction with the at least one software application utilizing the secondary decentralized dynamic profile to evaluate a response time and latency associated with the execution of the interaction; and
in response to determining that the evaluated response time and latency associated with the execution of the interaction satisfies a predetermined response time and latency threshold, execute the interaction with the at least one software application utilizing the secondary decentralized dynamic profile.

20. The non-transitory computer-readable medium of claim 15, wherein the instructions further cause the one or more processors to:
subsequent to deleting the secondary decentralized dynamic profile:
train an artificial-intelligence algorithm based at least in part on the request to execute the interaction with the at least one software application and the execution of the interaction with the at least one software application utilizing the secondary decentralized dynamic profile; and
execute, in response to the training of the artificial-intelligence algorithm, a artificial-intelligence model to generate a user recommendation for one or more future interactions with the at least one software application.
